(19) United States
(12) Patent Application Publication
(10) Pub. No.: US 2018/0021199 A1
(43) Pub. Date: Jan. 25, 2018

(54) GARMENT FOR IMPROVED FOOT AND LEG ALIGNMENT AND IMPROVED CIRCLUATION

(71) Applicant: Joanne Halbrecht, Boulder, CO (US)

(72) Inventor: Joanne Halbrecht, Boulder, CO (US)

(21) Appl. No.: 15/253,633

(22) Filed: Aug. 31, 2016

Related U.S. Application Data
(60) Provisional application No. 62/364,127, filed on Jul. 19, 2016.

(51) Int. Cl. A61H 1/00

(52) U.S. Cl. CPC A61H 1/008; A61H 2205/106; A61H 2205/12; A61H 2205/108; A61H 2209/00

(57) ABSTRACT

A garment for a human lower extremity with variable elasticity in the toe, heel and body of the garment is provided. A band of decreased elasticity is incorporated into the body of the sock extending from the toe area to the proximal end of the garment. A novel method for applying the sock includes twisting the garment, which results in providing targeted neuromuscular stimulation by the band to the location on the human lower extremity that the user positions the band over, thus improving alignment, gait, balance, circulation, and decreasing swelling and injury. Twisting of the garment also selectively increases a level of compression applied by the garment at said location relative to a level of pressure applied at adjacent locations. The location of the band and amount of compression generated by the garment is customizable by the wearer, depending upon the degree of twist chosen by the wearer.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Patent Application No. 62/364,127, filed Jul. 19, 2016, the entire contents of which are hereby incorporated by reference and should be considered a part of this specification.

### BACKGROUND

### Field

The present invention is directed to a garment, and more particularly to a sock that improves foot and leg alignment and circulation.

### Description of the Related Art

Foot malalignment affects a significant portion of the population and can cause foot, ankle, knee, hip and back pain and lead to poor posture. During normal gait, the foot strikes the ground on the lateral side of the heel. As weight is transferred to the front of the foot during ambulation, the forefoot strikes on the medial side. Weight is distributed evenly across the foot. When the foot excessively pronates, the forefoot strikes the ground on the far medial side of the foot and weight is distributed unevenly across the bones and soft tissue of the foot and ankle. When the foot excessively supinates, the forefoot strikes the ground on the lateral side of the forefoot and weight is distributed unevenly across the bones and soft tissue of the foot and ankle. This uneven distribution of weight stresses the bones, ligaments, tendons and muscles. This increased stress can cause muscle weakness and fatigue, stress fracture, tendonitis, bursitis, malalignment of the bones, soft tissue and joint inflammation and ligamentous laxity.

A variety of products have been designed to correct excessive pronation or supination including corrective orthotics, supportive shoes and taping. Exercises to strengthen leg and foot muscles help correct the muscle imbalances in the foot to improve excessive pronation or supination. These exercises can only improve foot alignment to a certain degree and often the affected individual must wear orthotics or supportive shoes to further correct the imbalance.

Orthotics can be purchased over the counter or custom molded to the foot. More severe foot malalignment tends to respond better to the custom molded orthotics. One drawback of orthotics is that they can be difficult to become accustomed to and require daily use to be effective. Additionally, orthotics do not fit in all shoes. It can be difficult to discern which shoes are most supportive for the wearer's foot malalignment and the appearance of the shoe may not appeal to the wearer.

Taping provides neuromuscular stimulation to dynamically improve alignment and is most effective when constantly worn. However, it may be difficult for the wearer to apply taping to the appropriate location and to provide enough tension to be effective. If the tape becomes wet (e.g., due to bathing or sweating), the adhesive in the tape is weakened, which alters the tension in the fabric. Thus, taping can only be worn for a few days before it needs to be changed due to stretching and/or decreased effectiveness of the adhesive due to motion and breakdown of the skin-adhesive interface. Another drawback of taping is that it can be uncomfortable on the skin and can cause rash and irritation to the point that the wearer must discontinue its use.

Swelling in the foot and lower extremity occurs with injury, infection, poor circulation, inactivity, obesity, and medical conditions such as hypertension and diabetes. Methods for reducing swelling include exercises to strengthen the muscles which in turn squeeze the veins to deliver fluid away from the foot and lower leg. Pneumatic devices have been used to mimic the pumping action of muscles to decrease swelling. Compression stockings are designed to provide increased compression in the foot and ankle with compression gradually decreasing as the garment extends up the leg. This external compression increases the pressure in the soft tissue to mobilize excess fluid into the venous system. Compression stockings also compress the superficial veins in the foot and leg to prevent them from overfilling with blood. When the veins overfill, this can cause the blood to backflow with resulting venous congestion which is a source of pain, swelling, superficial blood clots and skin changes that can lead to ulceration.

Exercise to decrease swelling have limitations regarding the amount of swelling it will decrease and response also depends upon the etiology and severity of the swelling. Pneumatic devices are designed to be used when the wearer is not ambulatory and close to a source of electricity. Compression stockings are characteristically difficult to don and to doff because of the tightness of the knit structure, which results in the compression stocking having an increased compression level (or being pre-compressed) before the user puts them on, such that the compression stocking automatically applies an increased compression on the tissue when the user puts them on. Another drawback of compression stocking is that they may pinch and wrinkle, which can cause discomfort and/or pain in the user and lead them to remove the compression stocking, and are often not sized correctly.

### SUMMARY

In view of the above, there exists a need for a garment to improve leg alignment and circulation and does not suffer from the drawbacks described above. In particular, there is a need for a garment that can improve leg alignment and circulation and that is easily applied and removed, can be worn while sedentary and ambulating, fits in most shoes, can provide customizable compression and fit, does not irritate the skin, does not require an extensive period of time to get used to and does not lose effectiveness over time.

In accordance with one aspect of the invention, a device (e.g., sock) is provided to be worn on the foot and leg to provide neuromuscular stimulation and/or proprioception to improve limb alignment, muscle function, balance and gait. The device circumferentially envelopes the foot and leg and includes a band incorporated into the device that is more resistant to stretch than the body of the device. Unlike typical taping, the device can easily be applied by the wearer, can be readily removed for bathing, and its properties will not change over time. Also, unlike an orthotic, which provides static support to the foot, the device provides dynamic 3-dimensional neuromuscular stimulation in a garment which can be used with most shoe wear and adapting to its use requires little or no time. The device can be easily customized by the wearer by the degree of twist chosen, selectively targeting neuromuscular stimulation depending upon the wearer's malalignment, pain, symptomatology and muscular deficits.

In accordance with another aspect of the invention, a device (e.g. sock) is provided that compresses the soft tissues of the foot and leg to improve circulation and decrease swelling. Unlike compression stockings, the device is easy to don and the wearer customizes the amount of compression to the foot and leg by the degree of twist chosen (e.g., the degree to which the user twists the sock while on the leg to position the band at a desired location on the leg). Less twist results in less compression applied to the leg, and more twist results in higher compression applied to the leg. Segmental differences in compression can be created by the wearer by alternating less twisting with more twisting. Also, fit can be adjusted by the wearer as well. When the device is twisted more, the garment is made tighter which prevents wrinkling of the garment and pinching of the human lower extremity. By preventing wrinkling of the garment and pinching of the human lower extremity, the garment can avoid the drawbacks in existing devices (e.g., where wrinkling and pinching of compression stockings can cause discomfort or pain in the user, causing the user to remove the compression stocking). Doffing the garment is also made easy by simply untwisting while removing the garment. The device can be made of a comfortable, breathable fabric which in certain embodiments will wick sweat away from the skin and/or provide cooling properties to the foot and leg.

In accordance with one aspect, a dynamic garment for a human lower extremity that stimulates skin, nerves, and muscles to improve foot and leg alignment, balance, and gait is provided. The garment comprises a body configured to circumferentially envelop at least a portion of the human lower extremity, and a band that extends along at least a portion of the length of the body, the band being integrated with the body and comprising a material that is relatively less elastic than the material of the body. The garment is configured to be twisted by the user while in use to adjust a location of the band along a length of the human lower extremity to a user targeted location to thereby provide one or more of targeted neuromuscular stimulation and proprioception to improve one or more of an alignment of the human lower extremity, muscle function, balance and gait.

In accordance with another aspect, dynamic garment for a human lower extremity that stimulates skin, nerves, and muscles to improve foot and leg alignment, balance, and gait is provided. The garment comprises a body configured to circumferentially envelop at least a portion of the human lower extremity, the body comprising a first material. The garment also comprises a toe portion attached to a distal end of the body and a heel portion attached to another portion of the body. The toe and heel portions comprise a second material that is relatively less elastic as compared to the body and configured to engage a toe portion and heel portion of a human foot. The garment also comprises a band that extends from the toe portion of the garment, along at least a portion of a plantar side of the foot, wraps over a dorsal side of the foot and extends to a proximal end of the body. The band is optionally integrated with the body and optionally comprises a third material that is relatively less elastic than the first material. The garment is configured to be twisted by the user while in use, without wrinkling the body or pinching the human lower extremity, to adjust a location of the band along a length of the human lower extremity to a user targeted location to thereby provide one or more of targeted neuromuscular stimulation and proprioception to improve one or more of an alignment of the human lower extremity, muscle function, balance and gait.

In accordance with another aspect, a dynamic garment for compressing soft tissue in a human lower extremity is provided. The garment comprises a body configured to circumferentially envelop at least a portion of the human lower extremity, the body comprising a first material. The garment also comprises a toe portion attached to a distal end of the body and a heel portion attached to another portion of the body. The toe and heel portions comprise a second material that is relatively less elastic as compared to the body and configured to engage a toe portion and heel portion of a human foot. The garment is configured to be selectively twisted by the user while in use at one or more locations along a length of the human lower extremity to selectively increase a level of compression applied by the garment at said one or more locations.

In accordance with another aspect, a method for using a dynamic garment having a body and a band as described herein to stimulate skin, nerves, and muscles in a human lower extremity to improve foot and leg alignment, balance, and gait is provided. The method comprises applying the garment with the heel portion facing anteriorly. The method also comprises engaging one or more toes of the user's foot with the toe portion of the garment. The method also comprises twisting the garment about the foot until the heel portion of the garment engages the heel of the user's foot. The method also comprises selectively twisting the garment as it is pulled further up the human lower extremity to thereby adjust the location of the band along the length of the human lower extremity to the user targeted location to provide one or more of targeted neuromuscular stimulation and proprioception to improve one or more of an alignment of the human lower extremity, muscle function, balance and gait. Said twisting of the garment at a location on the human lower extremity increases a level of compression applied by the garment at said location.

### BRIEF DESCRIPTION OF THE DRAWINGS

FIG. 1 is a schematic view that illustrates the sock gathered by the user's hands and oriented with the heel facing forward. This is the opposite orientation a sock is usually applied. In the figures, the sock is being applied to the left foot and leg.

FIG. 2 is a schematic view that illustrates pulling the sock on to the foot where the toe of the garment engages the wearer's toes.

FIG. 3 is a schematic view that illustrates the sock being twisted counterclockwise after it has engaged the toes.

FIG. 4 is a schematic view that illustrates the bottom of the sock on the left foot and location of the band starting on the lateral aspect of the distal foot and extending medially to the arch to correct excessive pronation.

FIG. 5 is a schematic view that illustrates the sock further twisted until the heel is engaged.

FIG. 6 is schematic view that illustrates the sock pulled further up the leg while the wearer continues to twist the garment, as viewed from the lateral side of the sock. The degree of twist depends upon the wearer's preference.

FIG. 7 is a schematic view that illustrates the sock of FIG. 6, as viewed from the medial side of the sock.

FIG. 8 is a schematic view that illustrates the sock with a decreased degree of twist compared to FIG. 6, viewed from the lateral side of the sock.

FIG. 9 is a schematic view that illustrates the bottom of the sock on the left foot, with the distal aspect of the band being on the medial side and extending proximally to the lateral side of the foot for a wearer with excessive supination.

FIG. 10 is a schematic view that illustrates the sock in FIG. 8 with an increased degree of twist extending up the leg.

FIG. 11 is a schematic view that illustrates the sock on the left leg and location of the band for excessive pronation in the ankle-high length sock.

FIG. 12 is a schematic view that illustrates the sock on the left leg and location of the band for excessive pronation in the thigh-high length.

FIG. 13 is a partial schematic view of a portion of one embodiment of the sock turned inside out to show a structure of a band of the sock.

### DETAILED DESCRIPTION

As used herein, the terms “device” and “garment” are interchangeable. In the illustrated embodiments, the device or garment is a sock.

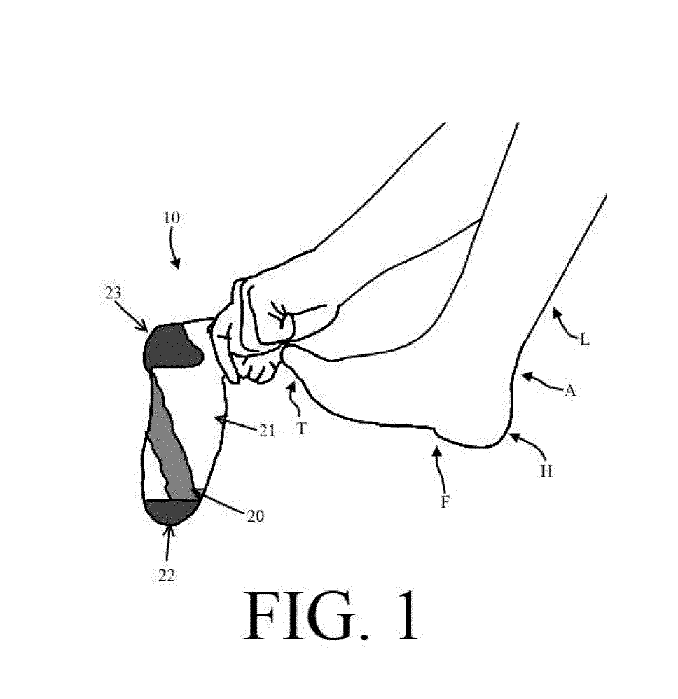

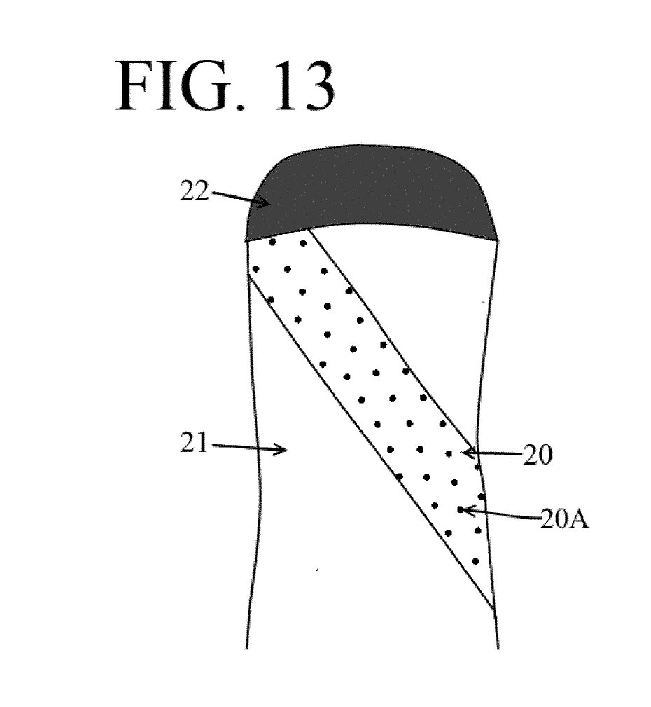

FIGS. 1-13 show one embodiment of a garment, specifically a sock or stocking 10. The sock 10 can optionally be made of an elastic knitted material (e.g., cotton or synthetic material) with a denser knit at the toe 22 and heel 23 portions of the sock 10. The purpose of this knit is to provide an anchor for the sock 10 that will remain in place when the sock is twisted or rotated. The toe 22 and heel 23 portions can optionally be thicker than the body (e.g., the remaining portion) 21 of the sock 10. In another embodiment, the toe 22 and heel 23 portions can optionally be thinner than the body 21 of the sock 10. The body 21 of the sock 10 can optionally be an elastic knit with decreased density between 10-50%, and increased elasticity between 10-50%, as compared to the density and elasticity of the toe 22 and heel 23 portions. However, in other embodiments, the body 21 of the sock 10 can have other density and elasticity values relative to the toe 22 and heel 23 of the sock 10. The sock 10 material may optionally contain metal ions and/or have properties that regulate skin temperature and/or wick sweat away from the skin. In one embodiment, the toe 22 and heel 23 portions can optionally include bumps or material that grips the skin to inhibit shifting of the toe 22 and heel 23 portions from engagement with the toes T and heel H of the foot F. Such bumps can be similar to the bumps 20A discussed below.

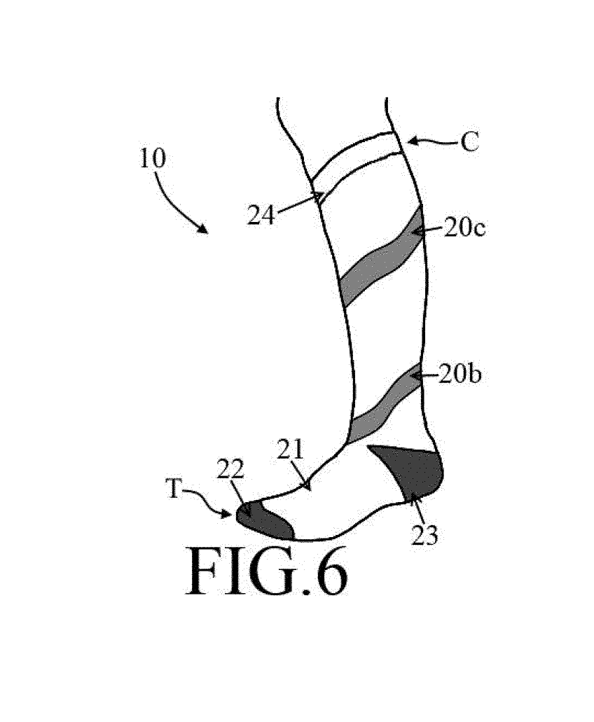

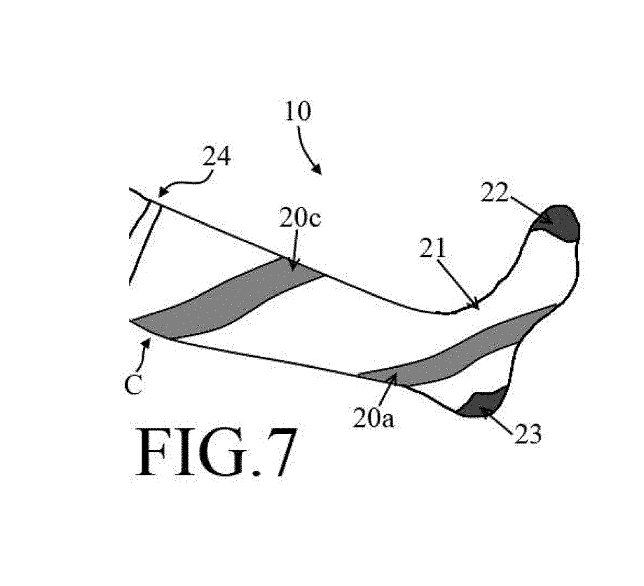

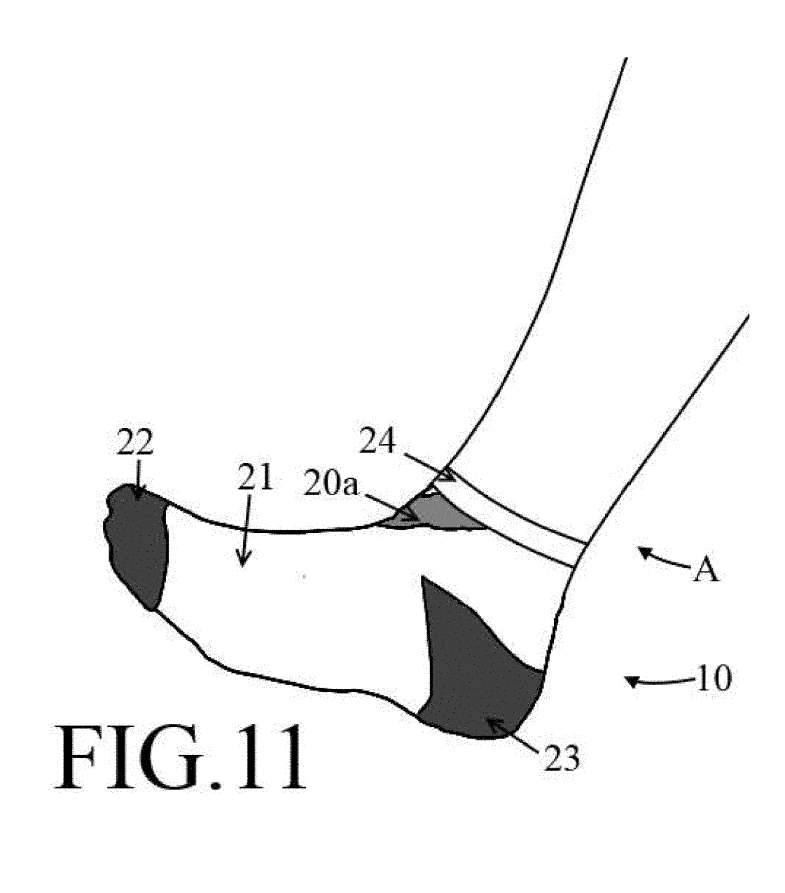

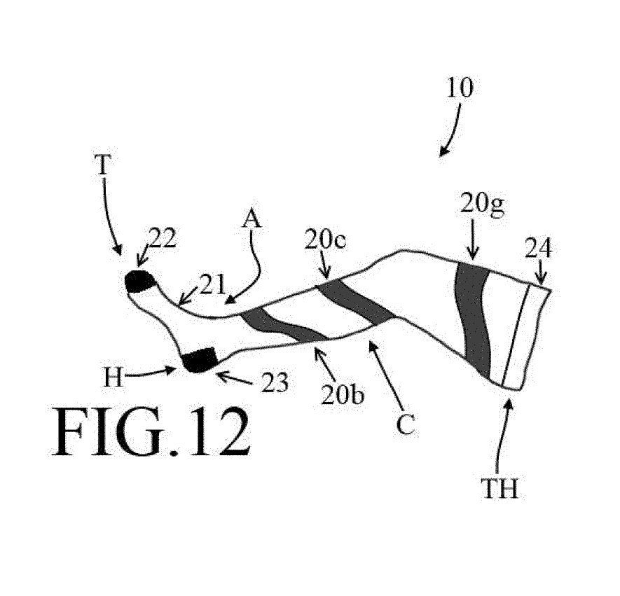

A band 20 (e.g., a single band) can optionally be incorporated into the body 21 of the sock 10 (e.g., in a seamless manner), such that the band 20 extends from a distal end (e.g., toe portion 22) of the sock 10 to a proximal end (e.g., band 24 at the ankle A in FIG. 11, band 24 at the calf C in FIGS. 6-7, and band 24 at the thigh TH in FIG. 12) of the sock 10. In another embodiment, the band 20 can be incorporated into the body 21 of the sock 10 in a seamed manner. The band 20 can have a width W that can be between one and three inches. However, in other embodiments, the width W of the band 20 can be greater or smaller than these values. In some embodiments, the width W of the band 20 can optionally vary along the length of the band 20. In other embodiments, the width of the band is generally constant along the length of the band 20. In one embodiment, the band 20 is optionally made of a 10-50% more tightly woven knit than the body 21. However, in other embodiments, the band 20 can have other suitable knit densities. In some embodiments, the band 20 is optionally made of the same material as the body 21 of the sock 10, but only differs in the knit density. In another embodiment, the material of the band 20 is different from the material of the body 21 of the sock. The band 20 can optionally extend from the toe portion 22 to a proximal end 24 of the sock 10. The band 20 can in one embodiment have a generally constant width W along its length. In another embodiment, the band 20 can optionally have a variable width W depending upon the muscles to be stimulated in the foot F and leg L. Advantageously, the band 20 is strategically located to provide targeted neuromuscular stimulation, which mimics the effect of skin taping techniques, but in a dynamic garment worn on the foot F and leg L. In one embodiment, shown in FIG. 11, the sock 10 is relatively short and extends from the user's toes T to their ankle A. In another embodiment, shown e.g. in FIGS. 6-7, the sock 10 has a relatively intermediate length (as compared to the short and long versions) and extends from the user's toes T to their calf C. In still another embodiment, shown in FIG. 12, the sock 10 is relatively long (as compared to the short and intermediate versions) and extends from the user's toes T to their thigh TH.

In another embodiment, the sock 10 can optionally include an elastomeric material, such as elastane or silicone, where the toe 22 and heel 23 are constructed to conform to the shape of the toes T and heel H to anchor the sock 10 in these locations. The band 20 that extends from the proximal end to the distal end of the sock 10 can optionally be incorporated into the sock 10 and be of an elastomeric material with 25-75% increased resistance to stretch as compared to the body 21 of the sock 10. In other embodiments, the elastomeric material can have lower or higher increased resistance to stretch when compared to the body 21 of the sock 10. The band 20 can optionally be of variable width W depending upon which muscles are to be stimulated, and can be strategically located to provide targeted neuromuscular stimulation which mimics the effect of skin taping techniques, but in a dynamic garment worn on the foot F and leg L.

Advantageously the sock 10 provides compression of the soft tissue of the lower extremity by way of the elastic nature of the fabric of the sock 10, and can be further augmented by optionally twisting the garment during application over the extremity (e.g., so that the band 20 extends in a spiral manner along the leg L). In one embodiment, unlike existing compression stockings, the sock 10 can apply a minimal amount of compression (e.g., about 1 mmHg) when pulled onto the user's leg, which facilitates the easy donning and doffing of the sock 10, as compared to existing compression stockings. The user can increase the compression provided by the sock 10 at one or more locations targeted by the user by twisting the fabric of the sock 10 at said locations (relative to adjacent locations). Such twisting of the sock 10 can apply an increased pressure to the soft tissues at said locations in the range of about 5 mmHg to about 40 mmHg. Accordingly, the level of compression applied by the sock 10 is provided by the amount of twist applied to the sock 10 while on the user's leg, not by a pre-compression of the garment due to a tightness of the knit of the garment prior to donning the garment.

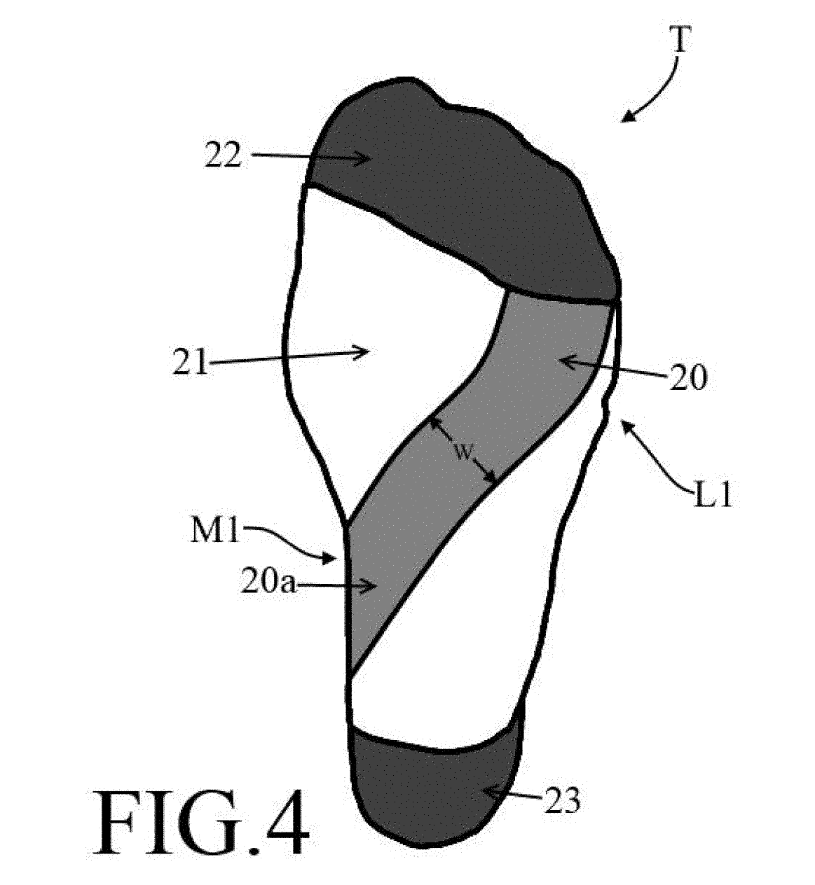

FIG. 1 is a schematic diagram showing a position of the sock 10 prior to application to the left foot F as seen from the lateral aspect or side. The sock 10 can be applied with the heel 23 facing outward or away from the user's toes T. As shown in FIG. 4, the band 20 can extend from a distal lateral dorsal side of the toe 22 of the sock 10 for a user with excessive pronation and can include a viscoelastic material with increased resistance to stretch as compared to the body 21 of the sock 10. In one embodiment, the band 20 can optionally include bumps 20A or material that grips the skin for the purpose of neuromuscular stimulation and/or proprioception. The bumps can optionally be made of the same material as the band 20, but provide raised off the surface of the band 20 to contact the skin. In another embodiment, the bumps can optionally be made of a different material (e.g., a viscoelastic material, such as silicone) than the material of the band 20. The material of the sock 10 at the toe 22 and heel 23 can have decreased elasticity as compared to the body 21 of the sock 10 to maintain position of the sock 10 on the toe T and heel H of the user's foot F during application and use.

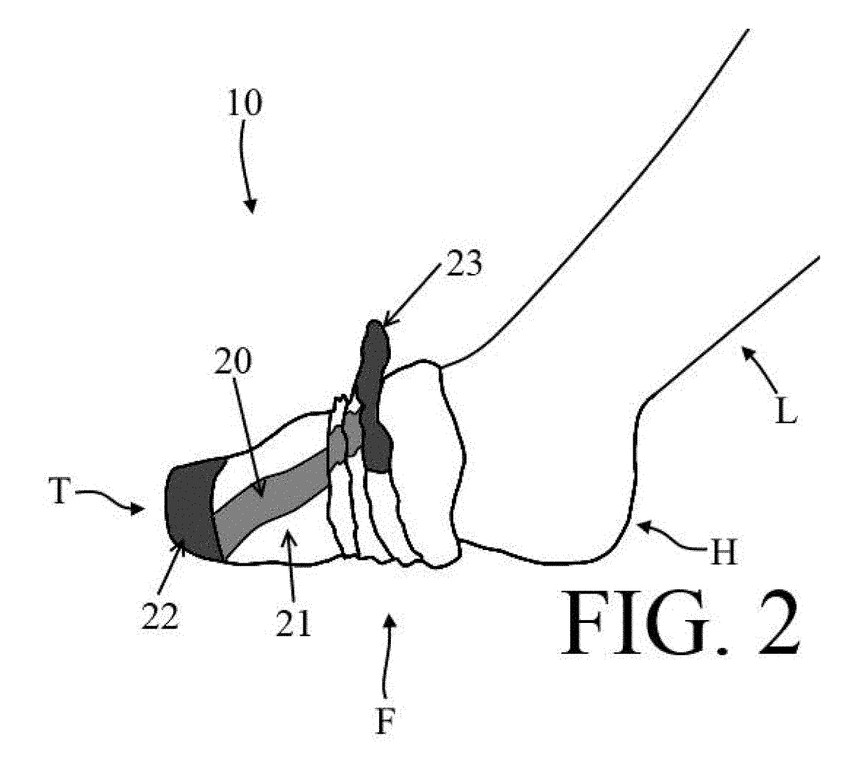

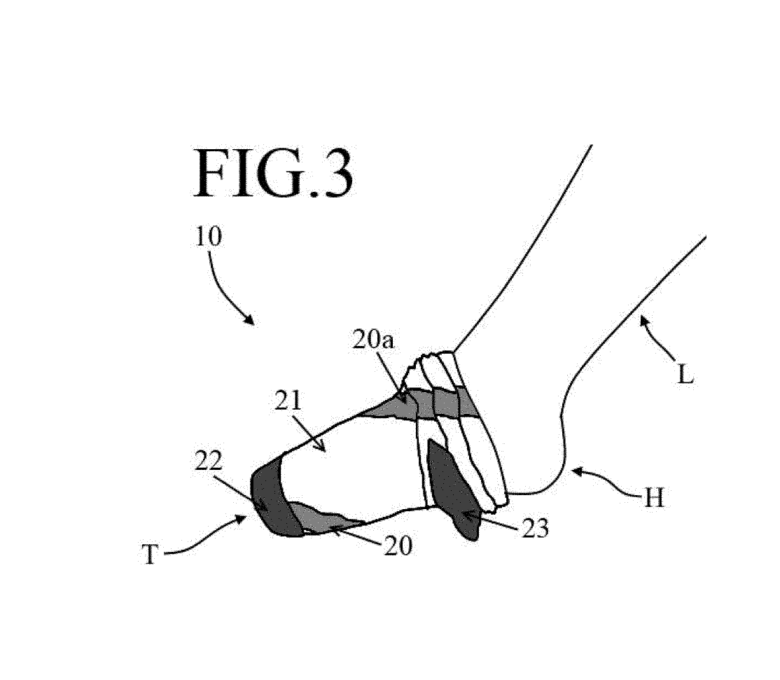

FIG. 2 shows the sock 10 pulled onto the toes T of the foot F. The toe portion 22 of the sock 10 engages the toes T and the band 20 is disposed on the dorsal and lateral sides of the foot F, and the heel portion 23 of the sock 10 is on the dorsal side of the foot F. The sock 10 is then twisted counterclockwise as shown in FIG. 3, to reposition the band 20 and heel portion 23 to the plantar side of the foot F while the toe portion 22 remains in place and secured to the toes T of the user's foot F; such twisting also increases a compression force provided by the sock 10 between the toe portion 22 and heel portion 23. Once repositioned from the dorsal side to the plantar side, the band 20, the band 20 can extend across the sole of the foot F as shown in FIG. 4. As shown in FIG. 4, a first portion 20a of the band 20 extends from a lateral side L1 at the toe 22 of the sock 10 to a medial side M1 of the foot F over the arch. Twisting the sock 10 in a specific direction advantageously provides 3-dimensional neuromuscular stimulation to improve leg alignment and proprioception to improve (e.g., create a more normal) gait and muscle efficiency, decrease muscle fatigue and inhibit injury. Twisting the sock 10 also advantageously provides customized or targeted compression, as desired by the user, to decrease swelling and improve circulation in the foot F and leg L. After applied to the toes T, the sock 10 is twisted 180 degrees until it engages on the heel H. The sock can then be twisted between zero and 360 degrees as it is pulled up the leg L to vary the level of compression applied to the leg L as well as to position the band 20 as desired to provide for targeted neuromuscular stimulation. In another embodiment, the sock 10 can instead be rotated clockwise (e.g., where there is excessive pronation of the right foot F).

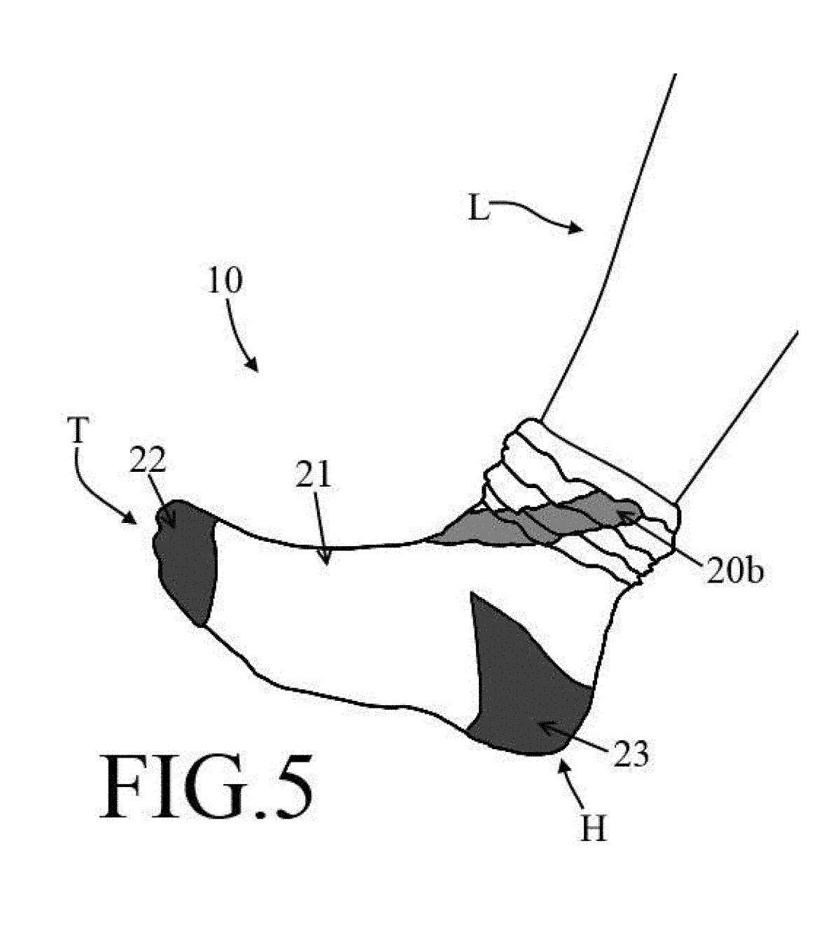

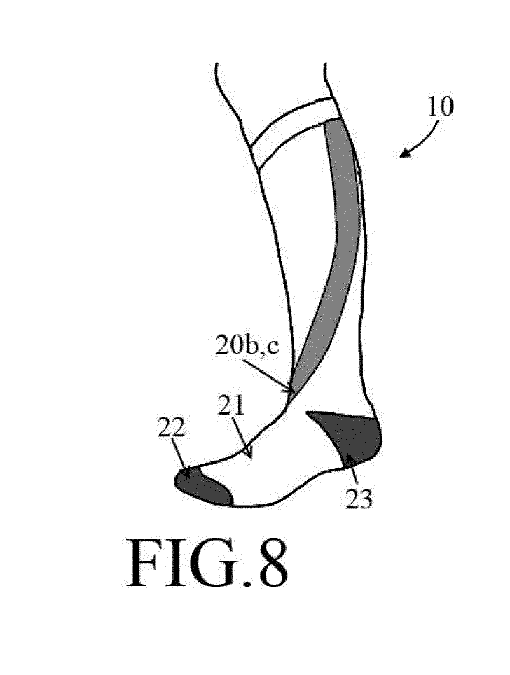

With reference to FIG. 5, the heel 23 of the sock 10 is engaged on the wearer's heel H. The band 20 which has the first portion 20a extending medially in FIG. 4, extends up to a second portion 20b of the band 20 adjacent the user's ankle A. The wearer can choose the location of the band 20 on the leg L as the sock 10 is pulled up the leg L by degree the sock is twisted. This degree of twist also customizes the amount of compression provided by the sock 10 on the leg L to the wearer's preference. FIG. 6 shows the sock 10 pulled up the leg L with the band 20 extending in a twisting manner from the second portion 20b up to a third portion 20c of the band 20 generally adjacent the user's calf C with a high degree of twist. FIG. 7 shows the sock 10 from the medial side of the leg L, which shows the first portion 20a of the band 20 extending from the medial side of the foot F upward toward the ankle A and then twisting toward the third portion 20c of the band 20 generally adjacent the user's calf C. The fabric at the top 24 of the sock 10 can optionally include an elastic fabric and can optionally grip the skin. If the wearer chooses relatively less compression by twisting the band 20 by a relatively lower amount, the placement of the second and third portions 20b, 20c of the band 20 can be disposed more laterally on the leg L, as shown for example in FIG. 8.

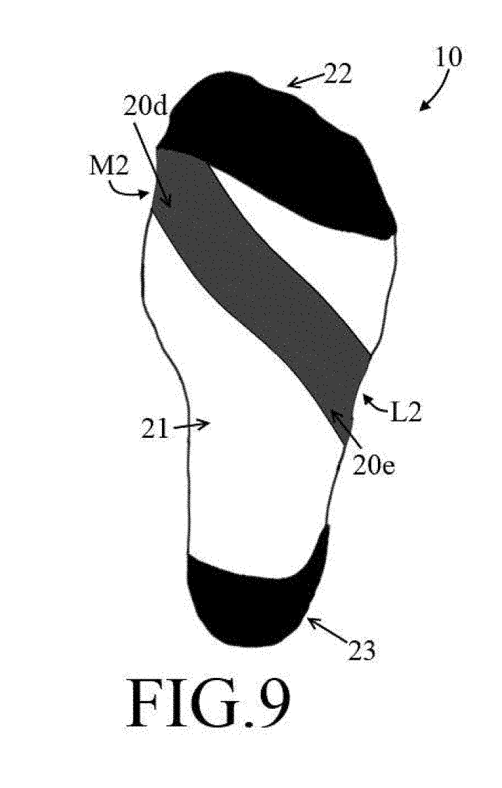

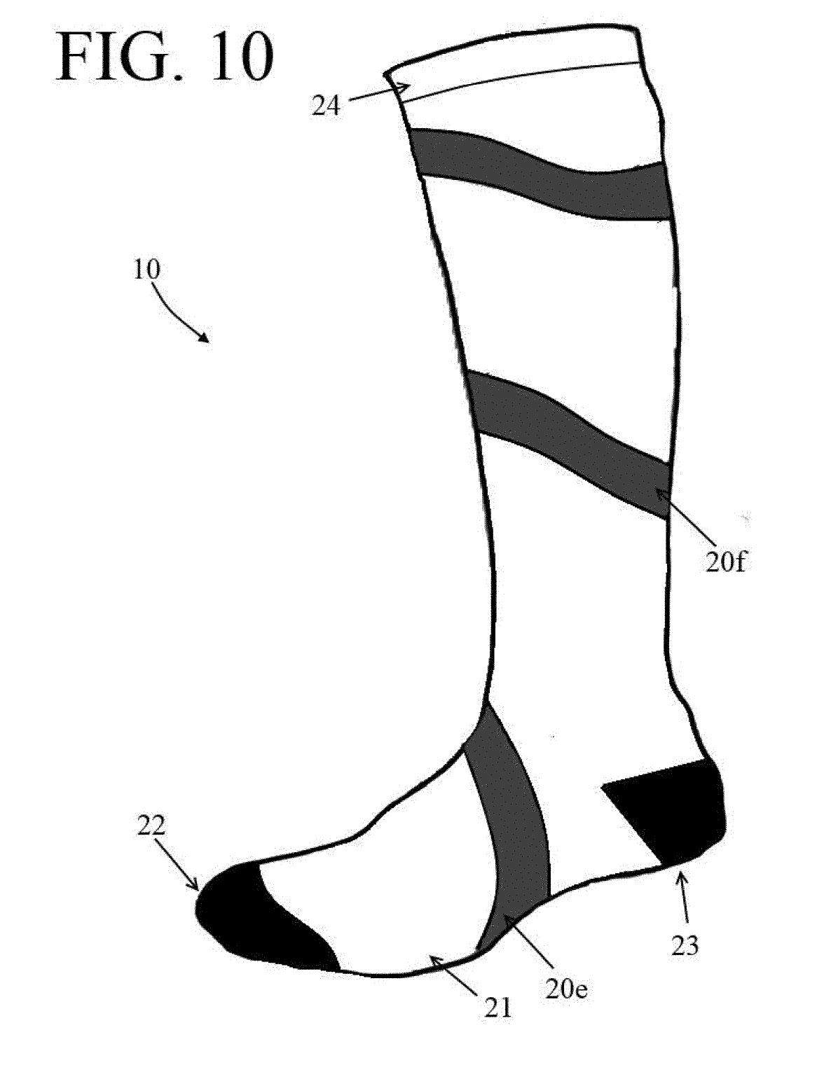

In the embodiment illustrated in FIGS. 1-8 and discussed above, the sock 10 was designed for a wearer with excessive pronation. In another embodiment, if a wearer has excessive supination, the sock 10 can optionally have the band 20 located on the opposite side, as in FIG. 9, so that it extends from the medial side M2 of the foot F at the toe 22 of the sock 10 to the lateral side L2 of the foot F along the plantar side of the foot F to provide neuromuscular stimulation, 3-dimensional tension and proprioception. The band 20 can extend from a distal medial 20d portion to the plantar lateral portion 20e to improve the malalignment. As the sock 10 is further pulled up the leg L in FIG. 10, the plantar lateral portion 20e transitions onto the dorsal side of the foot F and then transitions to a leg portion 20e that is twisted around the user's leg L toward the band 24 at the proximal end of the sock 10. The degree of twist and resulting location of neuromuscular stimulation and compression is customized by the wearer by twisting the sock 10 to position the band 20 as desired along the user's leg L.

The sock 10 is optionally available in 3 lengths: calf-high as in FIGS. 6,7 and 8, ankle-high as in FIG. 11 and thigh-high as in FIG. 12. In the ankle-high version, neuromuscular stimulation, improved proprioception and compression are isolated to the foot F and ankle A, where it can advantageously aid a wearer with mild increased pronation and/or mild foot swelling. The calf-high length version of the sock 10 can advantageously aid a wearer with moderate to severe increased pronation and/or more significant foot/leg swelling. The thigh-high length version of the sock 10 can advantageously aid a wearer with moderate to severe pronation and/or significant foot/leg swelling in and ambulatory and sedentary individual due to the increased surface area provided in the device for neuromuscular stimulation, proprioception and compression.

In one embodiment, the sock 10 can be used to treat existing malalignment of the foot and/or leg, as described above, as well as to reduce or inhibit swelling by improving blood circulation in the user's legs. In another embodiment, the sock 10 can be used to inhibit such problems from developing. In still another embodiment, the sock 10 can be used as an athletic accessory to enhance performance by facilitating blood circulation in the user's legs and provide neuromuscular stimulation, proprioception and compression as desired by the user.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. For example, though a garment described in embodiments above includes a band, in other embodiments the band can be excluded so that the garment provides user adjusted compression to tissue via the twisting of the garment as desired by the user, and advantageously without wrinkling the garment or pinching the user's skin. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A dynamic garment for a human lower extremity that stimulates skin, nerves, and muscles to improve foot and leg alignment, balance, and gait, comprising:
a body configured to circumferentially envelop at least a portion of the human lower extremity, the body comprising a first material;
a toe portion attached to a distal end of the body and a heel portion attached to another portion of the body, the toe and heel portions comprising a second material that is relatively less elastic as compared to the body and configured to engage a toe portion and heel portion of a human foot; and
a band that extends rearwardly along a plantar side of the body at an oblique angle relative to a longitudinal axis of the garment from the toe portion of the garment toward the heel portion of the garment such that the band extends along a majority of a distance between the toe portion and the heel portion of the garment, the band wrapping once onto a dorsal side of the body at a location of the body distal of the heel portion of the garment and extends to a proximal end of the body, the band being integrated with the body and comprising a third material that is relatively less elastic than the first material,
wherein the garment is configured to be twisted to adjust a location of each of a plurality of portions of the band relative to an adjacent portion of the band along a length of the garment proximal of the heel portion of the garment such that the location of each of the plurality of band portions can selectively be adjusted from one circumferential location on the garment to a different circumferential location on the band to thereby define a plurality of band trajectories between the heel portion of the garment and a proximal end of the garment to thereby provide one or more of targeted neuromuscular stimulation and proprioception to improve one or more of an alignment of the human lower extremity, muscle function, balance and gait.

2. The garment of claim 1 wherein a width of the band is between about 1 inch and about 3 inches.

3. The garment of claim 1 wherein a width of the band varies along the length of the garment.

4. The garment of claim 1 wherein the band is configured to extend along the plantar side of the foot from a distal lateral side of the foot to a proximal medial side of the foot to correct abnormal pronation of the foot.

5. The garment of claim 1 wherein the band is configured to extend along the plantar side of the foot from a distal medial side of the foot to a proximal lateral side of the foot to correct abnormal supination of the foot.

6. The garment of claim 1 wherein one or both of the toe portion and the heel portion of the garment is configured to grip a skin of the lower human extremity to keep the garment in place during use.

7. The garment of claim 1 wherein the third material of the band is chosen from the group consisting of an elastomeric material and a knit material.

8. The garment of claim 1 wherein the band is integrated with the body in a seamless manner, the garment configured to be twisted by the user without wrinkling the body or pinching the human lower extremity.

9. The garment of claim 1 wherein the band comprises a plurality of raised bumps configured to grip a skin of the lower extremity and to provide one or both of neuromuscular stimulation and proprioception.

10. The garment of claim 1, wherein selectively twisting of the garment at a location on the human lower extremity increases a level of compression applied by the garment at said location.

11. (canceled)

12. (canceled)

13. A dynamic garment for compressing soft tissue in a human lower extremity, comprising:
a body configured to circumferentially envelop at least a portion of the human lower extremity, the body comprising an elastic fabric that defines and a plurality of circumferential body portions where each of the plurality of body portions is configured to be selectively twisted relative to an adjacent body portion without wrinkling the body or pinching said human lower extremity to thereby adjust a level of compression provided by the body at said at body portion, the level of compression varying from about 1 mm Hg when the garment is off the lower human extremity or donned linearly on the lower human extremity without twisting, and wherein the level of compression varies between about 5 mm Hg and about 40 mm Hg depending on an amount of twisting of the body portion; and
a toe portion attached to a distal end of the body and a heel portion attached to another portion of the body, the toe and heel portions comprising a second material that is relatively less elastic as compared to the body and configured to engage a toe portion and heel portion of a human foot.

14. The garment of claim 13 wherein the garment has a length such that the proximal end of the body is configured to extend to a user's lower extremity anatomy chosen from a group consisting of the ankle, the calf and the thigh.

15. The garment of claim 13 wherein the first material is chosen from the group consisting of an elastomeric material and a knit material.

16. The garment of claim 13 further comprising a band that extends from the toe portion of the garment, along at least a portion of a plantar side of the foot, wraps over a dorsal side of the foot and extends to a proximal end of the body, the band being integrated with the body in a seamless manner and comprising a third material that is relatively less elastic than the first material, the band having a width of between about 1 inch and about 3 inches, wherein selective twisting of one or more body portions relative to adjacent body portions of the garment angularly repositions one or more sections of the band along the length of the garment, the band configured to provide one or more of targeted neuromuscular stimulation and proprioception to improve one or more of an alignment of the human lower extremity, muscle function, balance and gait.

17. (canceled)

18. (canceled)

19. (canceled)

20. (canceled)

21. The garment of claim 13, further comprising a band that extends rearwardly along a plantar side of the body at an oblique angle relative to a longitudinal axis of the garment from the toe portion of the garment toward the heel portion of the garment such that the band extends along a majority of a distance between the toe portion and the heel portion of the garment, the band wrapping once onto a dorsal side of the body at a location of the body distal of the heel portion of the garment and extends to a proximal end of the body, the band being integrated with the body and comprising a third material that is relatively less elastic than the first material.
